(19) United States
(12) Patent Application Publication
(10) Pub. No.: US 2024/0367151 A1
(43) Pub. Date: Nov. 7, 2024

(54) SOLID SUPPORT MATERIAL FOR CARBON DIOXIDE CAPTURE

(71) Applicant: Saudi Arabian Oil Company, Dhahran (SA)

(72) Inventor: Mohammed Abdulmajeed Al-Daous, Thuwal (SA)

(21) Appl. No.: 18/311,688

(22) Filed: May 3, 2023

(51) Int. Cl. B01J 20/30; B01J 20/18; B01J 20/28

(52) U.S. Cl. CPC B01J 20/3078; B01J 20/186; B01J 20/28097

(57) ABSTRACT

A method for forming a solid support material and the solid support material are provided. The method includes making a silicate precursor solution (solution A), making a calcium precursor solution (solution B), mixing solution B into solution A while stirring, forming a hydrogel, and heating the hydrogel to form a precursor solid. The precursor solid is calcined to form the solid support material.

### TECHNICAL FIELD

This disclosure relates to a solid support material for the capture of carbon dioxide composed of calcium particles encapsulated within silicalite.

### BACKGROUND

Solid base is defined as a material that act as a base and interact favorably with an acid reactant. A solid base is generally characterized by the exposure of a basic group on the surface. Mostly, basic sites can be activated by the removal of water or CO₂ from the surface. Basicity is exhibited by numerous materials, such as single-metal oxides (MgO, TiO₂, CaO, ZnO, and others), supported alkali metals (Na/MgO, K/K₂CO₃, and others), mixed-metal oxides (MgO—Al₂O₃, ZnO—SiO₂, MgO—TiO₂, and others), zeolites (X, USY, and others), hydrotalcite-type anionic clay, asbestos-based materials, carbon-based materials, and anion exchange resin.

Hydrogenation, transesterification, CO₂ reforming and aldol condensation are among the wide-ranging catalytic applications in which catalysts with a basic supports are employed. The reaction of CO₂ hydrogenation requires an interplay between an acid and base. The reaction occurs between the acidic CO₂ and the basic surface sites within a catalyst. Basic supports contribute to CO₂ dissociative adsorption, enhancement of CO₂ conversion, and reduction of coke deposition on the surface of catalysts.

The basic character of CaO and MgO is known to increase the adsorption of CO₂, which provides high catalytic activity. However, bulk CaO or MgO are low-surface area materials, lowering productivity. Further, nano-sized, high-surface area forms of these materials are susceptible to sintering.

### SUMMARY

An embodiment described herein provides a process for forming a solid support material. The process includes making a silicate precursor solution (solution A), making a calcium precursor solution (solution B), mixing solution B into solution

A while stirring, forming a hydrogel, and heating the hydrogel to form a precursor solid. The precursor solid is calcined to form the solid support material.

Another embodiment described herein provides a solid support material. The solid support material includes a silicalite including micropores, and nanoparticles of calcium oxide, calcium hydroxide, or both, encapsulated in the micropores of the silicalite.

### BRIEF DESCRIPTION OF DRAWINGS

FIG. 1 is a process flow diagram of a method for making a solid catalyst support that includes calcium oxide (CaO) encapsulated in silicalite.

FIG. 2 is a plot of a powder x-ray diffraction of Ca/silicalite after calcination, showing the silicalite-1 structure (MFI) structure.

FIG. 3 is a scanning electron micrograph (SEM) micrograph of CaO/silicalite.

FIG. 4 is a plot of the temperature program desorption (TPD) of carbon dioxide (CO₂) from samples of silicalite, CaO, and CaO/silicalite.

### DETAILED DESCRIPTION

Embodiments described herein provide a solid support material and the synthesis of the solid support material for the capture of CO₂. The solid support material includes calcium oxide (CaO) particles encapsulated within a microporous silicalite. After formation, the solid support material can be impregnated with a catalytic metal, for example, for carbon dioxide reforming, such as nickel, iron, ruthenium, or a combination thereof, among others. Further, the solid support material can be impregnated with other catalytic metals, including platinum, palladium, rhodium, and iridium, among others, to function in different types of reactions.

The CaO is in the form of nanoparticles that are encapsulated in the pores of a microporous silicalite. The encapsulated CaO serves a number of purposes, for example, the nanoparticles of CaO particles have a high surface area, increasing their efficacy in CO₂ capture. Further, the encapsulation of the nanoparticles within the silicalite micropores decreases the sintering of the CaO.

The synthesis of silicalite generally uses an aqueous solution having a pH of greater than about 12. However, at high pH, calcium forms insoluble calcium hydroxide that precipitates from solution, lowering or eliminating the incorporation into the silicalite. To avoid this, the techniques described herein use a chelating agent that stabilizes the calcium during the synthesis. Once the synthesis is completed, the chelating agent, as well as any templating agents used in the silicalite formation, are burned off during a calcining operation, forming the solid support material.

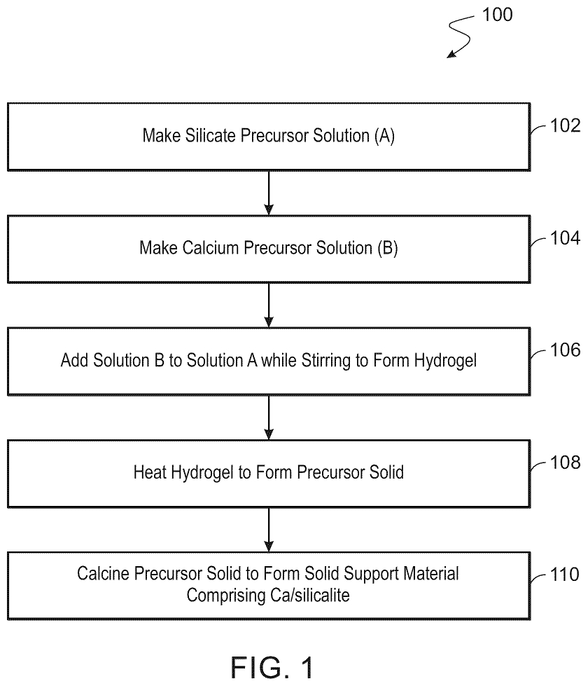

FIG. 1 is a process flow diagram of a method 100 for making a solid support material that includes nanoparticles of calcium oxide (CaO) encapsulated in the micropores of silicalite. The method 100 begins at block 102, with the formation of the silicate precursor solution (solution A). In various embodiments, the precursor solution can be formed in a water solution by mixing a silicate precursor, such as tetraethylorthosilicate, with a templating agent, such as tetrapropylammonium hydroxide. The templating agent directs the formation of the silicalite structure. The solution of the templating agent can have a pH of 12 by itself, or the pH can be raised to that value with the addition of KOH or NaOH.

At block 104, the calcium precursor solution (solution B) is mixed. In various embodiments, this is performed by mixing a soluble calcium precursor, such as calcium chloride, and a chelating agent such as D-gluconic acid in a water solution. Since the silicalite synthesis route uses aqueous solution medium with hyperalkaline (pH>12) conditions, and since calcium forms insoluble precipitates under alkaline conditions, calcium stabilizing/chelating organic agents are employed in the synthesis to prevent this. A common organic chelating agent is D-gluconic acid (2R,3S,4R,5R)-2,3,4,5,6-pentahydroxy hexanoic acid. D-gluconic acid is a polyhydroxy carboxylic acid used in applications in the food, pharmaceutical, dye, metal and cement industries. Calcium cations are readily associated in different ratios with gluconic acid and form water-soluble amino complexes with variable stabilities. The calcium ions in these species are easily mobilized to interact with the silica-based species in the gel phase during ambient temperature aging of the silicalite and hydrothermal crystallization.

These applications are mostly related to its weak acidic character and the strong complexing capacity of its various deprotonated forms (including the D-gluconate anion, and those containing alcoholate moieties) forming under near-neutral to hyperalkaline (pH>12) conditions. The enhanced stability of the gluconate complexes with respect to other monocarboxylic acids or salts is mainly due to the presence of alcoholic OH groups next to the carboxy late anchor group, giving rise to the formation of five-membered chelate rings.

At block 106, solution B is added to solution A while stirring to form the hydrogel. The resulting solution is stirred for between about 12 hours and about 20 hours, or between about 14 hours and about 18 hours, or for about 16 hours. The temperature during the stirring is maintained around ambient, for example, between about 18° C. and 26° C., or between about 20° C. and about 24° C., or at about 22° C.

At block 108, the hydrogel is heated to form a precursor solid by hydrothermal crystallization. In some embodiments, this is performed by loading the hydrogel into a vessel and heating the hydrogel for a period of time. In some embodiments between about 150° C. and about 190°° C., or between about 160° C. and about 180° C., or at about 170° C. In some embodiments, the period of time is between about 5 days and about 15 days, or between about 7 days and about 13 days, or between about 9 days and about 11 days, or for about 10 days. The resulting precursor solid is isolated was filtered, washed, and dried, for example, at between about 80° C. and about 120° C., or between about 90° C. and 110° C., or at about 100° C. Upon hydrothermal crystallization of the silicalite hydrogel, a significant portion of the calcium-gluconate complexes remain grafted to the silicalite surface.

The mechanism of interaction of the calcium-gluconate complexes with the silica hydrogel is thought to be through hydrogen bonding. The calcium-gluconate complexes remain unaltered in the silicate solution and end up grafted to the silicate surface.

At block 110, the precursor solid is calcined to form the solid support material. In various embodiments, the calcination may be performed at an elevated temperature in air. For example, the temperature is maintained between about 500° C. and about 700° C., or between about 500° C. and about 600° C., or at about 550° C. The temperature is reached using a temperature ramp of between about 0.5° C./min and about 3° C./min, or between about 1° C./min and about 2° C./min, or at about 1.5° C./min. The maximum temperature is maintained for between about 15 hours and about 21 hours, or between about 17 hours and about 19 hours, or for about 18 hours to remove the organic content.

When the final silicalite product is calcined in air to burn off the template and the gluconic acid chelate, the calcium, either oxide (CaO) or hydroxide (Ca (OH)₂), end-up occluded in the silicalite micropores. This is termed “Ca/silicalite” herein. The encapsulated calcium species impart the solid support materials with base character, as demonstrated through their interaction with CO₂, as discussed herein.

### Examples

### Preparation of Ca/Silicalite

Ca/Silicalite was prepared according to the process disclosed with respect to FIG. 1. To prepare a sample of the Ca/Silicalite, two separate precursor solutions were prepared. Solution (A) was prepared by adding 20.0 gram of tetraethylorthosilicate (TEOS) (Aldrich, 97%) to 38.86 grams of tetrapropy lammonium hydroxide (TPAOH) (Aldrich, 1 Molar TPAOH, aqueous solution) with stirring for ˜16 hours at room temperature. Solution (B) was prepared by dissolving 1.1134 grams of CaCl₂·2H₂O (Aldrich, 99%) in 24.208 grams of DI water, subsequently 4.13 grams of D-gluconic acid sodium salt (D-GAS) was added, and the solution was stirred at room temperature until all the salts were dissolved. Solution B was then added to solution A at once while stirring. The clear solution was further stirred for 6 hours at room temperature to form a hydrogel with a molar ratio of 1 SiO₂:0.4 TPAOH:0.08 CaO:0.197 D-GAS (D-gluconate):32 H₂O.

The hydrogel was loaded into an approximately 0.25-liter pressure vessel, and heated at 170° C. for 10 days (without stirring). At the end of this period, the pressure vessel was cooled to ambient temperature and the contents were filtered, washed, and dried at 100° C. The dried Ca/silicalite sample was then calcined by heating at a rate of 1.5 degrees Celsius per minute (° C./min) to 550° C. in air and maintained at 550° C. for at least 18 hours to remove the organic content. The calcium content in the resulting Ca/silicalite product was found to be 3 wt. % by ICP run at a commercial contract lab.

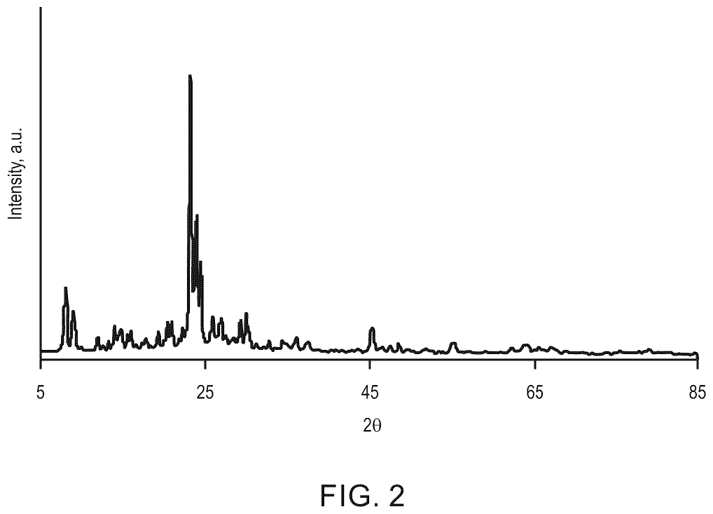

FIG. 2 is a plot of a powder x-ray diffraction (XRD) of Ca/silicalite after calcination at 550° C. showing the MFI structure. XRD patterns of the catalysts were obtained using a Rigaku MiniFlex-600 X-ray Diffractometer with Cu Kα (λ=0.154059 nm) radiation, fixed slit incidence (0.25° divergence, 0.5° anti-scatter, specimen length of 10 mm) and diffracted optics (0.25° anti-scatter, 0.02 mm nickel filter). Data was obtained at 40 kV and 15 mA from 5 to 75 (2θ) using a PIXcel detector with a PSD length of 3.35° (2θ), and 255 active channels.

When compared to the reference International Centre for Diffraction Data (ICDD) database card no. 04-007-735, the X-ray powder diffraction of the calcined product was found to be that of a silicalite-1 (mordenite framework inverted or MFI) structure. The X-ray powder diffraction analysis is depicted in FIG. 1

The presence of the calcium oxide in the silicalite was verified by scanning electron microscopy (SEM). The CO₂ uptake activity and character of the Ca/Silicalite materials was established using CO₂-TPD.

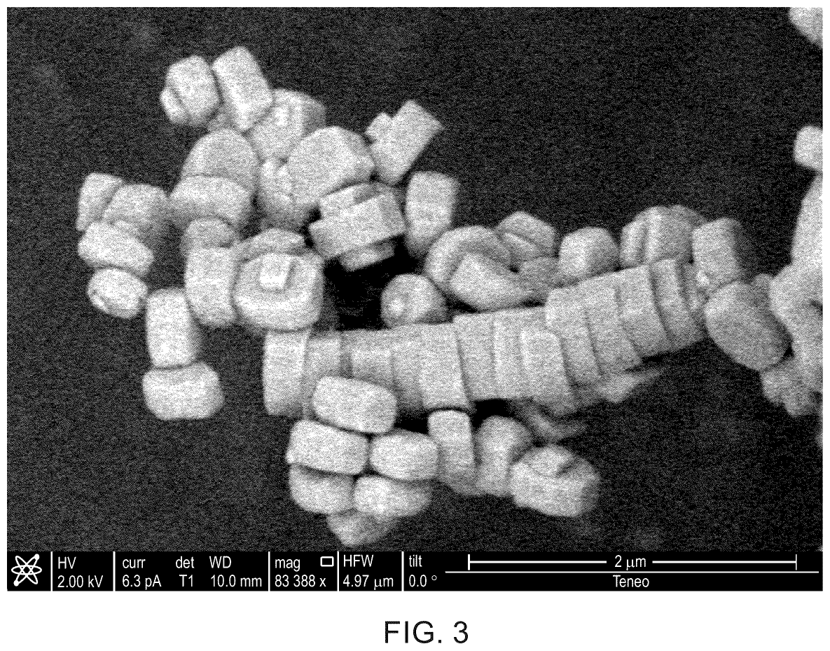

FIG. 3 is an SEM micrograph of CaO/silicalite. The SEM micrograph of the Ca/silicalite sample shows only silicalite crystals, and an absence of any extraneous solid debris that could indicate calcium products. This is an indication that the calcium species present is encapsulated within the silicalite crystals.

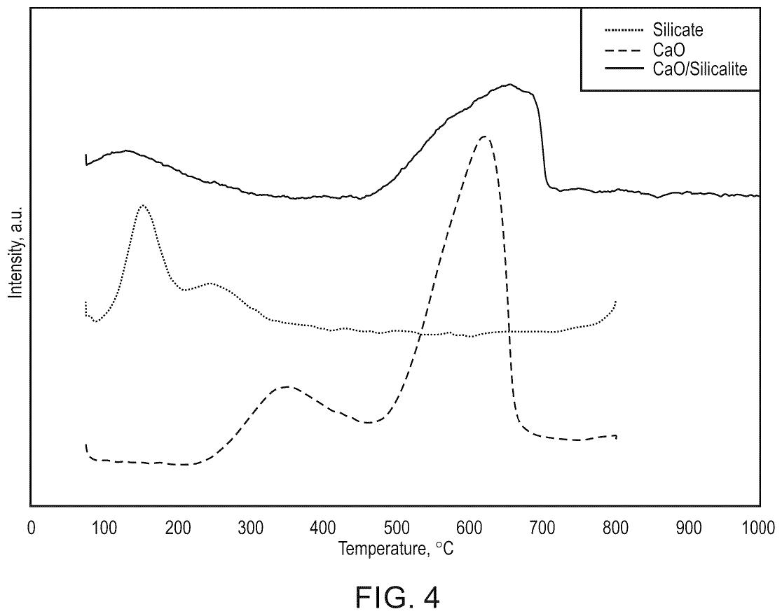

FIG. 4 is a plot of the temperature program desorption (TPD) of carbon dioxide (CO₂) from samples of silicalite, CaO, and CaO/silicalite. The CO₂-TPD was used to assess the basicity of the solid support material, by measuring the CO₂ uptake and release of each of the materials. The pure silicalite exhibits rather weak CO₂ uptake indicating weak base sites. The pure CaO powder exhibited a rather strong base character, in which the CO₂ uptake was significant and the CO₂ release occurred at high temperatures. The Ca/silicalite materials exhibited two different base sites, weak base sites like those of pure silicalite and strong base sites like those of pure CaO. This is a confirmation of the presence of CaO in the Ca/silicalite materials.

### Embodiments

An embodiment described in examples herein provides a process for forming a solid support material. The process includes making a silicate precursor solution (solution A), making a calcium precursor solution (solution B), mixing solution B into solution A while stirring, forming a hydrogel, and heating the hydrogel to form a precursor solid. The precursor solid is calcined to form the solid support material.

In an aspect, combinable with any other aspect, making solution A includes mixing a silicate precursor with water to form an aqueous solution, and mixing a templating compound into the aqueous solution. In an aspect, combinable with any other aspect, the silicate precursor includes tetraethylorthosilicate (TEOS). In an aspect, combinable with any other aspect, the templating compound includes tetrapropy lammonium hydroxide (TPAOH).

In an aspect, combinable with any other aspect, making solution B includes dissolving a calcium salt in water to form an aqueous solution, and adding a complexing agent to the aqueous solution. In an aspect, combinable with any other aspect, the calcium salt is calcium chloride. In an aspect, combinable with any other aspect, the complexing agent is D-gluconic acid sodium salt.

In an aspect, combinable with any other aspect, the method includes stirring the mixture of solution B and solution A for about 14 hours to about 20 hours.

In an aspect, combinable with any other aspect, the method includes heating the hydrogel for about 9 days to about 11 days at a temperature of between about 160° C. and about 180° C. to form the precursor solid.

In an aspect, combinable with any other aspect, the method includes calcining the precursor solid at a temperature of between about 500°° C. and about 600° C. for about 17 hours to about 19 hours to form the solid support material.

In an aspect, combinable with any other aspect, the method includes using the solid support material to support a metallic catalyst.

In an aspect, combinable with any other aspect, the metallic catalyst includes a carbon dioxide reforming catalyst. In an aspect, combinable with any other aspect, the metallic catalyst includes nickel.

Another embodiment described in examples herein provides a solid support material. The solid support material includes a silicalite including micropores, and nanoparticles of calcium oxide, calcium hydroxide, or both, encapsulated in the micropores of the silicalite.

In an aspect, combinable with any other aspect, the silicalite includes a silicalite-1 structure (MFI).

In an aspect, combinable with any other aspect, a calcium content of the solid support material is about 3 wt. %.

In an aspect, combinable with any other aspect, the solid support material includes weak base sites and strong base sites.

In an aspect, combinable with any other aspect, the solid support material is formed by making a silicate precursor solution (solution A), making a calcium precursor solution (solution B), mixing solution B into solution A while stirring, forming a hydrogel, heating the hydrogel to form a precursor solid. The precursor solid is calcined to form the solid support material.

In an aspect, combinable with any other aspect, the silicate precursor solution includes tetraethylorthosilicate and tetrapropylammonium hydroxide.

In an aspect, combinable with any other aspect, the calcium precursor solution includes calcium chloride and D-gluconic acid sodium salt.

As used in this disclosure, the term “about” or “approximately” can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such through one or more multiple dependent claim, one or more features from a claimed combination can, in some cases, be excised from the combination, and the claimed combination may be directed to a sub-combination or variation of a sub-combination.

Other implementations, alterations, and permutations of the described implementations are also within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

What is claimed is:

1. A process for forming a solid support material, comprising:
making a silicate precursor solution (solution A);
making a calcium precursor solution (solution B);
mixing solution B into solution A while stirring, forming a hydrogel;
heating the hydrogel to form a precursor solid; and
calcining the precursor solid to form the solid support material.

2. The process of claim 1, wherein making solution A comprises:
mixing a silicate precursor with water to form an aqueous solution; and
mixing a templating compound into the aqueous solution.

3. The process of claim 2, wherein the silicate precursor comprises tetraethylorthosilicate (TEOS).

4. The process of claim 2, wherein the templating compound comprises tetrapropylammonium hydroxide (TPAOH).

5. The process of claim 1, wherein making solution B comprises:
dissolving a calcium salt in water to form an aqueous solution; and
adding a complexing agent to the aqueous solution.

6. The process of claim 5, wherein the calcium salt is calcium chloride.

7. The process of claim 5, wherein the complexing agent is D-gluconic acid sodium salt.

8. The process of claim 1, comprising stirring the mixture of solution B and solution A for about 14 hours to about 20 hours.

9. The process of claim 1, comprising heating the hydrogel for about 9 days to about 11 days at a temperature of between about 160° C. and about 180° C. to form the precursor solid.

10. The process of claim 1, comprising calcining the precursor solid at a temperature of between about 500° C. and about 600° C. for about 17 hours to about 19 hours to form the solid support material.

11. The process of claim 1, comprising using the solid support material to support a metallic catalyst.

12. The process of claim 11, wherein the metallic catalyst comprises a carbon dioxide reforming catalyst.

13. The process of claim 11, wherein the metallic catalyst comprises nickel.

14. A solid support material, comprising;
a silicalite comprising micropores; and
nanoparticles of calcium oxide, calcium hydroxide, or both, encapsulated in the micropores of the silicalite.

15. The solid support material of claim 14, wherein the silicalite comprises a silicalite-1 structure (MFI).

16. The solid support material of claim 14, wherein a calcium content of the solid support material is about 3 wt. %.

17. The solid support material of claim 14, comprising weak base sites and strong base sites.

18. The solid support material of claim 14, wherein the solid support material is formed by:
making a silicate precursor solution (solution A);
making a calcium precursor solution (solution B);
mixing solution B into solution A while stirring, forming a hydrogel;
heating the hydrogel to form a precursor solid; and
calcining the precursor solid to form the solid support material.

19. The solid support material of claim 18, wherein the silicate precursor solution comprises tetraethylorthosilicate and tetrapropylammonium hydroxide.

20. The solid support material of claim 18, wherein the calcium precursor solution comprises calcium chloride and D-gluconic acid sodium salt.
